(19) United States
(12) Patent Application Publication
(10) Pub. No.: US 2003/0031177 A1
(43) Pub. Date: Feb. 13, 2003

(54) Systems and methods for exchanging information between optical nodes

(76) Inventors: Marc Robidas, Chelmsford, MA (US); Arvind Puntambekar, Westford, MA (US)

Correspondence Address: LAHIVE & COCKFIELD, 28 STATE STREET, BOSTON, MA, 02109, US

(21) Appl. No.: 09/865,112

(22) Filed: May 24, 2001

(51) Int. Cl. H04L 12/56

(52) U.S. Cl. 370/392; 370/410

(57) ABSTRACT

Methods and systems for exchanging information between optical nodes are provided. A method for peer discovery between a first optical node and a second optical node comprises connecting the first optical node and the second optical node with at least two trunks, and sending a packet, which includes an identifier, from the first optical node to the second optical node. A method of establishing Internet Protocol connectivity between a first optical node and a second optical node connected by at least one trunk is also provided.

### TECHNICAL FIELD

The present invention relates generally to telecommunications, and specifically relates to information exchange between two optical nodes.

### BACKGROUND OF THE INVENTION

As the number of independent networks, or Autonomous Systems (AS), in internetworks increase, so too does the need for efficient gateway routing protocols to save costs and time. These protocols help route Internet traffic from source to destination efficiently. One standard interior gateway routing protocol utilized within an AS is Open Shortest Path First (OSPF). In the OSPF protocol, networks, routers, and lines are represented by abstract graphs. Each arc of the graph is assigned a cost according to a metric that can involve, for example, distance, and delay. The OSPF protocol then identifies a traffic path having less cost.

The types of connections and networks that OSPF supports includes point-to-point lines between two routers, multi-access networks with broadcasting, such as many local area networks (LAN), and multi-access networks without broadcasting, such as many wide area networks (WAN). However, although successful and widely used, the standard OSPF protocol has not been extended to support communications equipment that has entered the information networks market recently. Present interior gateway routing protocols, such as OSPF, have not been modified to include new hardware equipment currently in the marketplace. Thus, functionality, and architecture are lacking to achieve peer discovery and connectivity between nodes in selected network systems.

### SUMMARY OF THE INVENTION

The present invention relates to gateway routing of traffic in networks having optical switches. The invention permits optical routing to occur between nodes by using a control channel and peer discovery. The present invention is well suited for optical networks where there may typically be several optical trunks between a pair of nodes. Some of the trunks may be used to establish IP connectivity, while the remaining trunks may be burdened with a lighter protocol.

In particular, a method for peer discovery between a first optical node and a second optical node is provided. The method includes connecting the first optical node and the second optical node with at least two trunks, and sending a packet from the first optical node to the second optical node. The packet includes an identifier. The packet may be sent over an in-band control channel, and originate in a management controller in the first optical node. Moreover, a trunk manager module on the management controller can perform the peer discovery. The packet may be sent from the first optical node to the second optical node, and the identifier can include at least one of a router identification, a chassis number, a slot number, and a port number. The packet may further include an optical routing parameter having at least one of a virtual private number associated with at least one of the trunks, a conduit number associated with at least one of the trunks, and an OSPF area identification.

A method for peer discovery between a first optical node and a second optical node is also provided herein. The method includes connecting the first optical node and the second optical node with at least one trunk, and sending a packet from the first optical node to the second optical node. The packet includes an identifier, and an optical routing parameter. The identifier can include at least one of a router identification, a chassis number, a slot number, and a port number. The packet can be sent over an in-band control channel, and can originate in a management controller in the first optical node. In addition, a trunk manager module on the management controller can perform the peer discovery. The packet can be sent from a port interface card in the first optical node to the second optical node. Furthermore, the optical routing parameter can include at least one of a virtual private number associated with the at least one trunk, a conduit number associated with the at least one trunk, and an OSPF area identification.

Also provided herein is a system for peer discovery between a first optical node and a second optical node. The system includes a controller in the first optical node, a line card in the first optical node linked to the controller, and a trunk manager module on the controller for sending a packet to the second optical node via the line card. The packet has an identifier and an optical routing parameter. The identifier can include at least one of a router identification, a chassis number, a slot number, and a port number, and the optical routing parameter can include at least one of a virtual private number associated with the at least one trunk, a conduit number associated with the at least one trunk, and an OSPF area identification.

A method is also provided herein for establishing Internet Protocol (IP) connectivity between a first optical node and a second optical node connected by at least one trunk. The method includes forming a tunnel between a controller in the first optical node and a line card in the first optical node, and sending a packet from the controller to the line card. With the use of a forwarding device in the line card, the packet is forwarded from the line card to the second optical node over the at least one trunk, such as a synchronous optical network (SONET) trunk.

### BRIEF DESCRIPTION OF THE DRAWINGS

The aforementioned features and advantages, and other features and aspects of the present invention, will become better understood with regard to the following description and accompanying drawings.

FIG. 1 shows two optical nodes, which function as optical switches, connected by SONET trunks, according to the teachings of the present invention.

FIG. 2 shows three inter-connected optical nodes, according to one embodiment of the present invention.

FIG. 3 shows two optical nodes and two multiplexers/demultiplexers, consistent with principles of the present invention.

FIG. 4 shows an SMC to Port Interface Card (PIC) inter-module tunnel, according to principles of the present invention.

FIG. 5 shows an OSPF running two daemons per SMC, according to the teachings of the present invention.

FIG. 6 shows an optical node configured to support an IP in IP tunnel, according to principles of the present invention.

FIG. 7 shows a flow chart for peer discovery between a first optical node and a second optical node, according to principles of the present invention.

FIG. 8 shows a flow chart for establishing Internet Protocol (IP) connectivity between a first optical node and a second optical node connected by at least one trunk, according to the teachings of the present invention.

### DETAILED DESCRIPTION OF THE INVENTION

The illustrative embodiment provides systems and methods for peer discovery between optical nodes that permit an optical node to learn the router Internet Protocol (IP) address and port identification of a network peer. In addition, the illustrative embodiment provides a method of establishing IP connectivity between a pair of optical nodes connected by at least one trunk. The trunk can be a SONET trunk.

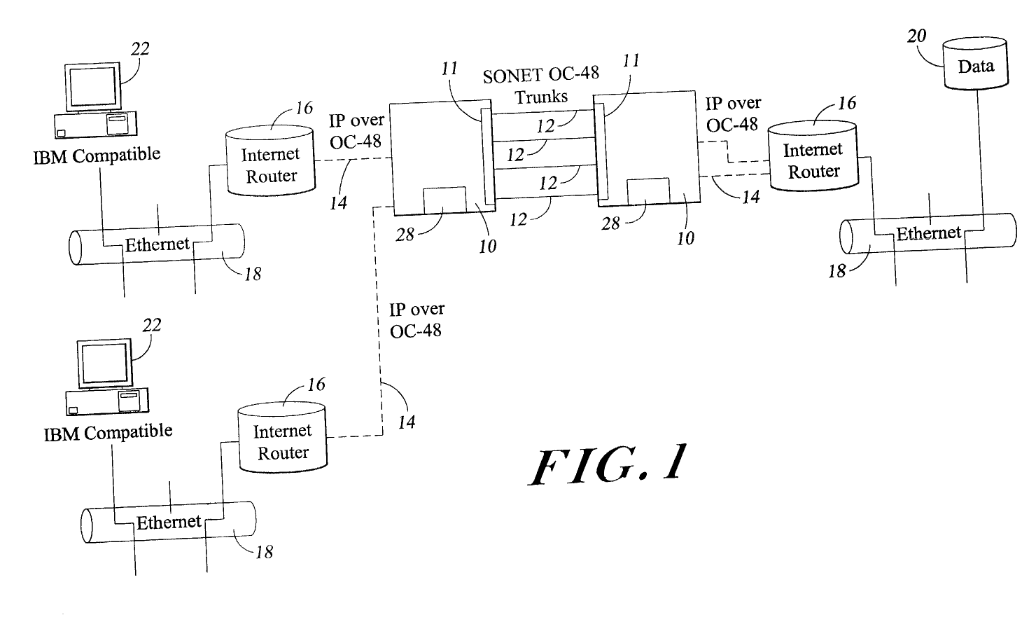

Referring to FIG. 1, two optical nodes 10 that function as optical switches are shown connected by SONET trunks 12. The optical nodes 10 are connected to Internet routers 16 via IP over OC-48 lines. The Internet routers 16 are linked to Ethernets 18 and data files 20 accessed by clients 22. The optical nodes 10 may be optical switches. A suitable optical switch is the Sycamore SN-16000, available from Sycamore Networks, Inc. of Chelmsford, Mass.

The configuration depicted in FIG. 1 is intended to be merely illustrative and not limiting of the present invention. The present invention may also be practiced with other configurations. For example, the local area networks (LANs) need not be Ethernets and many other network components may be included in the configuration.

The optical nodes provide SONET OC-48 cross-connect functionality. An IP router is located in a management controller, such as a serial management controller (SMC) 28, disposed within the optical nodes 10. The control channel provides a transparent connection between the SMC IP routers, either as an in-band control channel through an OC-48 trunk or as an out-of-band control channel.

Optical node ports 11 are SONET OC-48 ports, operating at 1310 nm. The ports are SONET compliant Line Terminating Equipment and may be connected to SONET regenerators. Add/Drop Muxes or cross-connects. The user can configure which ports are the trunks versus line interfaces. The control channel bandwidth is provided by the SONET section and line overhead bytes. Each overhead byte provides 64 Kbps of full duplex, synchronous, bit oriented transport.

The section overhead bytes available include E1, F1, and DCC[1 . . . 3], which provide 320 Kbps of control channel bandwidth. The line overhead bytes available include E2, and DCC[3 . . . 12], which provide 640 Kbps of bandwidth. To maximize the control channel's capacity, the user can use section and line overhead bytes, resulting in a 960 Kbps pipe. This is possible when the trunk is transported via SONET unaware equipment, for example, a set of SN16000 trunks transported via SN8000 wavelength division multiplexer (WDM) equipment. The user can also use line overhead bytes only, resulting in a 640 Kbps pipe. This implies the trunk is connected to a SONET regenerator. The user can also use an out-of-band control channel, and the trunk is connected to a SONET Add/Drop Mux or cross-connect.

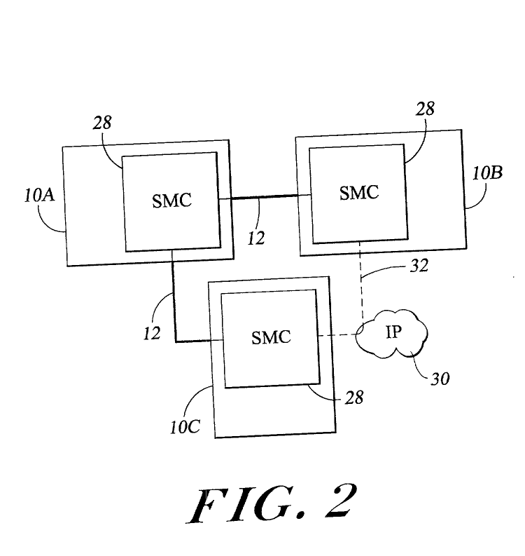

Referring to FIG. 2, three optical nodes 10A-C, like those shown in FIG. 1, illustrate that IP connectivity can be provided on the SN-16000 using the inband control channel over the SONET trunks 12 or the out of band control channel 32. The optical nodes 10B and 10C are connected to the optical node 10A by SONET trunks 12, such as OC-48 operating at 1310 nm. The optical nodes 10A-C include SMC cards 28. The SMC 28 contains an IP router (not shown).

The optical nodes 10A-C function as optical switches. For example, the optical nodes 10A-C may be SN-16000™ optical switches. In FIG. 2, IP connectivity between network nodes 10B and 10C exists via a 10/100base Ethernet electrical interface connected to IP routers 30. The dotted line 32 is indicative of an out-of-band control channel utilized to achieve IP in IP tunneling. IP is the network layer for the TCP/IP protocol. It provides packet routing, fragmentation and re-assembly through the data link layer. Tunneling enables one network to send its data via another network's connections. Tunneling works by encapsulating a network protocol within packets carried by the second network. IP connectivity may also be achieved by using the in-band control channel carried by the SONET trunks 12, according to the principles of the present invention.

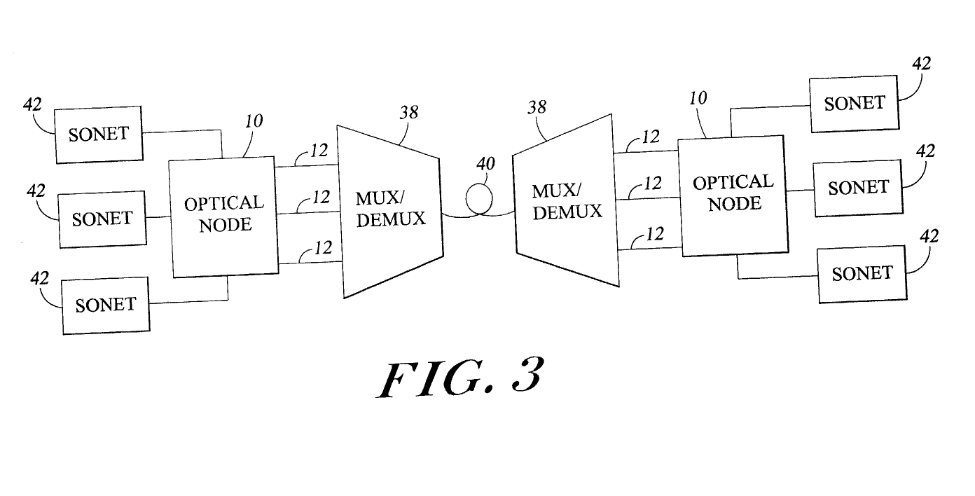

Referring to FIG. 3, two optical nodes 10 functioning as optical switches, such as SN16000 switches, are shown, with one on the ingress side, and the other on the egress side. Muxes 38, such as SN8000 multiplexes from Sycamore Networks, Inc., multiplex information from three SONET OC-48 trunks 12 onto a single optical fiber 40 and demultiplex the information on the egress side. One of the three OC-48 trunks can be configured to provide a 960 kbps in-band control channel for inter-SN16000 IP connectivity. The SONET equipment cannot use the SONET section/line overhead bytes across the trunks because the SN16000 ports are SONET Line Terminating Equipment. The three SONET trunks correspond to three SONET networks 42.

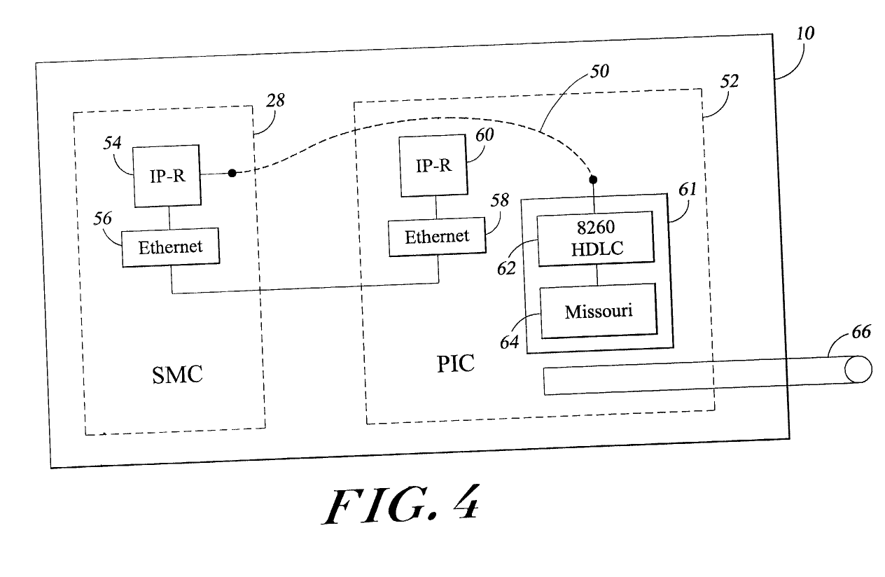

Referring to FIG. 4, an SMC to Port Interface Card (PIC) inter-module tunnel 50 is shown included in the optical node 10 presented in FIG. 1. The optical node 10 that functions as an optical switch, such as an SN16000, includes an SMC 28 and a PIC 52. The SMC 28 includes an IP router 54 connected to an Ethernet physical layer 56. The Ethernet physical layer 56 in the SMC 28 is connected to an Ethernet physical layer 58 in the PIC that is connected to an IP router 60 in the PIC and is utilized to interconnect the SMC 28 to the PIC 52. OC-48 ports are also located on the PIC. The inter-module tunnel 50 is established between an IP router 54 and a packet forwarding device 61. In one embodiment of the present invention, the packet forwarding device includes an HDLC controller 62 and a processing chip 64, such as a Missouri chip from Applied Micro Circuits Corporation, San Diego, Calif. The PIC 52 has eight OC-48 trunks 66, although, for clarity, only one is shown.

For two optical nodes 10, such as those shown in FIG. 3, to be capable of communication, the inter-module tunnel 50 is established to allow an exchange of information via the in-band control channel of the OC-48 trunk 66. Thus information can travel from the SMC 28 to the PIC 52 and out through the OC-48 trunk 66 to another optical node. In particular, information flows into the IP router 54, and, adding enough layer of encapsulation, the information flows to the PIC 10. The first layer of IP encapsulation is labeled with protocol IPv4. When information exits the IP router 60, the first IP header is removed by an IP tunnel on the line card, before adding HDLC encapsulation, and passing the information to the OC-48 trunk 66.

SONET overhead bytes are extracted by the chip 64 of the PIC 52. A field programmable gate array (FPGA) allows the software to select the section and line overhead bytes to be presented as a single bit pipe to the serial interface of a microprocessor, such as an MPC8260 microprocessor from Motorola™, which is configured as a high level data link control (HDLC) serial communication controller (SCC). This HDLC interface on the PIC is connected to an unnumbered IP interface on the primary SMC 28. The interface between the HDLC controller 62 and the chip 64 supports a bit oriented, bi-directional, clear channel.

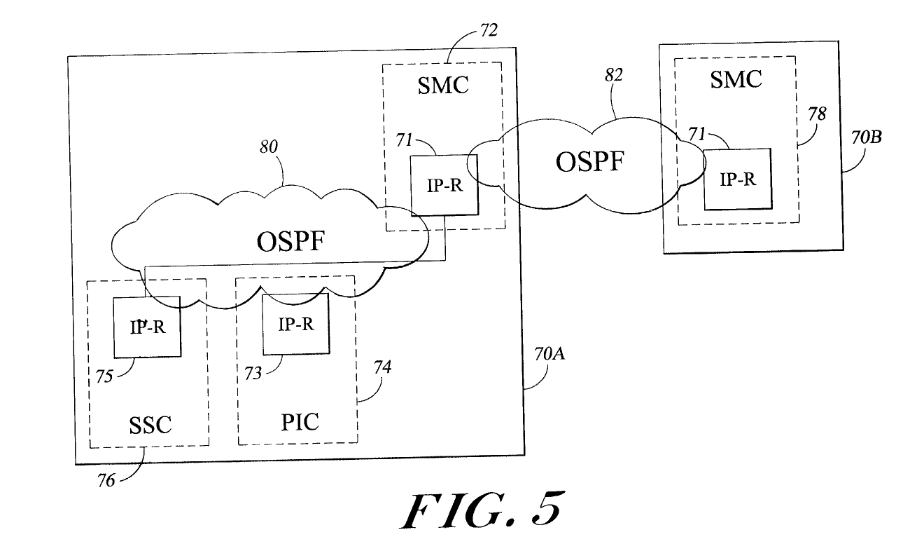

Referring to FIG. 5, an OSPF running two daemons per SMC is shown. Two optical nodes 70A and 70B, finctioning as optical switches, are shown. The optical node 70A includes an SMC 72 having an IP router 71, a PIC 74 having an IP router 73, and a SSC 76 having an IP router 75. The optical node 70B is shown having an SMC card 78 that includes an IP router 77.

The scope of the first OSPF daemon is inter-optical node topology. The SMC's public IP router interfaces are used to access the other IP routers, specifically NMS 100 Base-T ports, and all in-band and out-of-band control channels. The second OSPF daemon provides intra-optical node connectivity. Line cards, such as the SMC, PIC and SSC, have an IP router with two private interfaces that are connected to the redundant 100 Base-T on the backplane. A segment of this 100 Base-T is illustrated in FIG. 4 as the Ethernet connectivity between the PIC 52 and SMC 28.

OSPF provides IP connectivity in the dynamic routing protocol thereof in limited circumstances via public interfaces of the nodes. There are two segregated copies of OSPF that run, but the reachability of the internal cards is limited to the internal SMC (i.e., an external SMC is incapable of reaching those internal cards directly). The IP router 71 in the SMC 72 cannot make the IP router 73 in the PIC 74 visible outside the optical node 70A because the two OSPF regions 80 and 82 are segregated. As a result, a tunnel is used between the SMC 72 and the PIC 74, as shown in FIG. 5 according to the principles of the present invention. The IP router 73 in the PIC 74 is not visible to an external node in the network, but only privately visible to the SMC 72 within the same chassis.

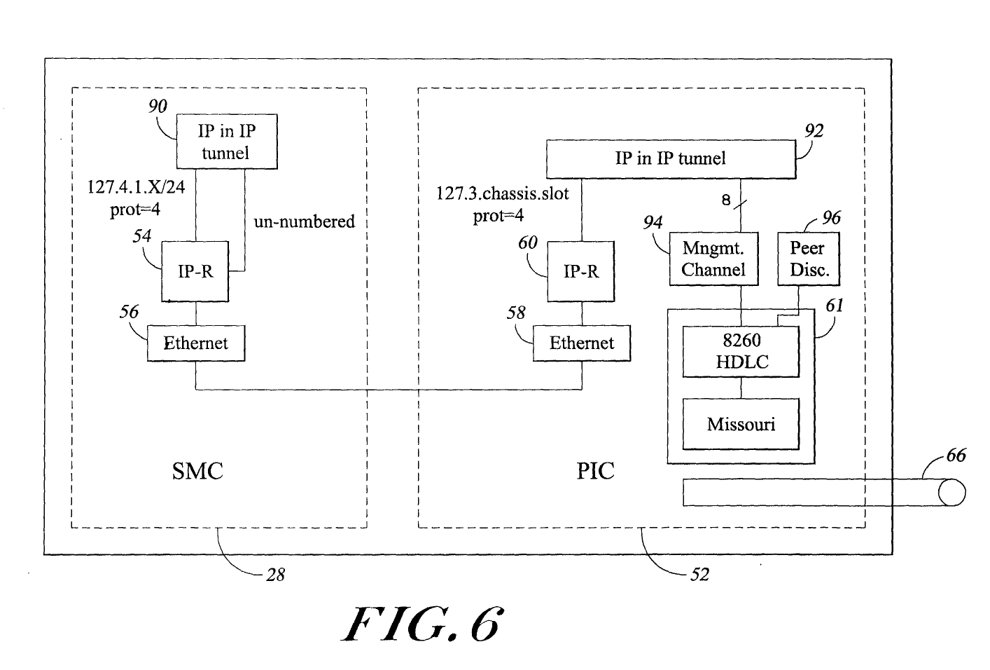

Referring to FIG. 6, an optical node configured to support an IP in IP tunnel is shown, according to principles of the present invention. The optical node 10 includes an SMC 28 and a PIC 52. The SMC includes an IP router 54 connected to an Ethernet physical layer 56. Also connected to the IP router 54 is an IP in IP tunnel 90, with the IP interface being unnumbered. The PIC includes an Ethernet layer 58 in communication with the Ethernet layer 56 in the SMC, which is connected to an IP router 60. The IP router 60 is connected to an IP in IP tunnel 92, which is connected to a management channel 94. An HDLC chip 62, connected to the chip 64, is linked to both a management channel 94 and a peer discovery 96.

The IP in IP tunnel 92 illustrates an IP address structured as 127.3.chassis.slot. In one embodiment, there are eight instances of the management channel 94, the peer discovery 96, the HDLC chip, the Missouri chip, and the OC-48 trunk. The IP address provided by the SMC 28 is utilized to identify the eight interfaces, one for each OC-48 port. The source IP address in the IP header from the SMC dictates to which of the eight management channels a packet of information is sent. Peer discovery is run over each of the eight instances as described in more detail below.

The in-band control channel has two components: the management channel 94 that provides inter-node IP connectivity, and Peer Discovery 96 that discovers the peer node's optical routing parameters. Both of these components statistically multiplex their frames over a common set of SONET overhead bytes. The frames are structured with a point-to-point protocol (PPP)-like header:

| | Management Channel | Peer Discovery |
|---|---|---|
| HDLC all stations address | FF (1 byte) | FF (1 byte) |
| HDLC unnumbered info. | 03 (1 byte) | 03 (1 byte) |
| frame | | |
| Protocol ID | 0025 (2 bytes) | 0035 (2 bytes) |
| Payload | IP v4 header and | Defined below |
| | Payload. | |
| CRC-16 | (2 bytes) | (2 bytes) |

a) Management Channel

The management channel 94 provides inter-node IP connectivity. The management channel 94 makes use of an RFC 1853 IP in IP tunnel to forward packets between the SMC 28 and the PIC 52. A PPP-like encapsulation is then used for the frames transmitted over SONET overhead bytes. The tunneled packets use an IP address from the SMC's set of 127.4.1.X/24, and with the PIC's address of 127.3.chassis.slot. In order to minimize the processing overhead of the tunnel, its MTU is 1480 bytes. This allows the 20 byte IP header for the tunnel to be added and not require fragmentation over the 1500 byte MTU used by the Ethernet interfaces (for inter-card communication). The PIC's tunnel uses the source IP address in the tunnel header to select one of eight possible trunks to forward the IP packet. The state of the unnumbered interface must follow the state of the control channel on the PIC 52; it should have an initial state of DOWN. The Link Manager will need to send physical layer state updates to the SMC tunnel. The Trunk Manager and Link Manager set up the SMC-PIC tunnel. The Trunk Manager on the SMC learns the tunnel's IP address (127.4.1.X) once the tunnel is successfully allocated on the SMC 28. The Link Manager then configures the other end of the tunnel, such that the PIC 52 can select one of eight trunks to forward a packet based on the source IP address in the tunnel's header. The SMC's IP in IP tunnel supports an allocation of a tunnel interface. A tunnel interface can be allocated and connected to a control channel on the PIC 52. The SMC's IP in IP tunnel also sets the tunnel's interface status. The tunnel's IP interface follows the state of the physical layer of the control channel on the PIC 52. An UP state occurs only when the following three conditions are met: the PIC card is present, the datalink layer and physical layer are UP.

The Trunk Manager module responds to Signalling's bandwidth requests. The Trunk Manager knows about a trunk's bandwidth capacity and utilization, but it does not know how the trunks are structured into channels. The trunk manager also configures the in-band control channel, and ensures that the associated SMC router interface's state follows the state of the physical layer (i.e. SONET overhead bytes) on the PIC port. The trunk manager notifies Signaling when a trunk with allocated bandwidth is physically DOWN.

The primary SMC instantiates a Trunk Manager during its initialization. The Trunk Manager listens on TCP port 9200 for one Resource Manager (bandwidth management), port 9300 for one Port Manager, and on port 9500 for multiple Link Manager on the PIC's. The Trunk Manager is responsive to the Resource Manager's bandwidth management commands as a result of the Resource Manager having only one outstanding bandwidth management command outstanding at a time, even though Signaling is capable of concurrent circuit processing. The Trunk Manager's responsiveness in servicing the Resource Manager and other events affects the rate of circuit processing. In one embodiment, the Trunk Manager should make non-blocking calls on its interfaces.

There is one Link Manager per PIC card that manages all ports. The Link Manager supports “add trunk” and “delete trunk” commands used by the Trunk Manager. The “add trunk” command specifies if an IP tunnel or Peer Discovery is to be configured by the Link Manager. The “delete trunk” command deletes any tunnel or Peer discovery object associated with the specified trunk

The Link Manager can issue a physical layer UP/DOWN, datalink layer UP/DOWN, and negotiated trunk parameters commands. The Trunk Manager performs any consistency check required between APS members.

b) Peer Discovery

The in-band control channel is a datalink layer capable of “peer discovery” that permits learning the peer node's router IP address, OSPF area ID and port ID. The control channel datalink layer provides a best attempt delivery with error detection over the HDLC link.

The SMC's Trunk Manager discovers its neighbors connected to each of its trunks and notifies Optical Routing of these trunks. Peer discovery involves having a node send its optical routing parameters and trunk identification over the in-band control channel to its neighbor. The node receiving the parameters ensures the optical routing parameters are consistent before notifying Optical Routing. The peer discovery parameters include chassis slot and port number, router ID of the node, OSPF area ID, Virtual Private Number of the trunk, and conduit identifiers used by the trunk. The Trunk Manager module on the SMC performs Peer Discovery. The Link Manager on the PIC card exchanges the above parameters as an opaque string every 3 seconds.

Peer Discovery can be used in 2 modes. In an open mode, the SwitchTrunk configuration record, a configuration record to control pertinent features and to describe the optical routing parameters within various trunks, does not specify the peer node parameters. Peer Discovery learns who is the peer node and forwards this information to Optical Routing. In a closed mode, the SwitchTrunk record is configured with the peer information and it ensures that the learned parameters are consistent with the configured parameters, effectively ensuring that the cabling and configuration are consistent.

The implementation consists of allowing the Trunk Manager on the SMC 28 to enable Peer Discovery on the selected trunks for a given PIC, and provides the optical routing parameters as a preformatted Type-Length-Value encoded string. The PIC's peer discovery process then exchanges this packet at three-second intervals over an UDLC datalink. When the PIC 52 receives new parameters over the HDLC datalink, those are forwarded to the Trunk Manager module on the SMC 28. The trunk manager then performs its consistency checks on the trunk. If successful, the optical routing daemon is notified of the new trunk. The trunk is deleted from optical routing if either the trunk's operational status becomes “down” or the optical routing parameters become inconsistent (a result from either a configuration update or optical routing parameters update from the remote node). The trunk manager registers the trunks with Optical Routing and notifies it about changes in bandwidth availability. This includes changes in the trunk's bandwidth availability due to APS switching, new peer router discovered or Loss of Light detected on the trunk.

The trunk is not deleted if stops receiving Peer Discovery packets from its peer. The Peer Discovery packet transmitted over the HDLC frame is formatted as follows by the, Link Manager on the PIC card:

| Name | Description |
|---|---|
| HDLC header | 4 bytes: FF030035 |
| Parameter update command | 4 bytes: 00000000 |
| Sequence Number | 4 bytes, starts at 0, incremented when new |
| | parameters are sent. This means if the |
| | parameters are unchanged, the packet sent |
| | every 3 seconds contains the same |
| | sequence number. |
| TLV - type: peer parameters | 2 bytes: 0001 |
| TLV - length | 2 bytes: the length includes the type, |
| | length and value fields. |
| TLV - value | 4 byte length field + peer discovery |
| | parameters. These parameters are opaque |
| | to the PIC cards discovery process. |
| TLV - type: contact interval | 2 bytes: 0002 |
| TLV - length | 2 bytes: 0006 (the length includes the |
| | type, length and value fields). |
| TLV - value | 2 bytes: 001E. (I.e., 30 seconds) |

The “peer parameters” are formatted by the SMC's Trunk Manager as follows:

| Name | Description |
|---|---|
| LV - type: trunk ID | 2 bytes: 0001 |
| LV - length | 2 bytes: 0004 |
| LV - value | 4 bytes: |
| | bit 31 reserved (0) |
| | bit [30..26] chassis |
| | bit [25..21] slot |
| | bit [20..15] port |
| | bit [14..0] reserved (0) |
| TLV - type: Virtual | 2 bytes: 0002 |
| Private Network | |
| TLV - length | 2 bytes: 0004 |
| TLV - value | 4 bytes: VPN identifier in the range [0..(2\hat{ }32)-1] |
| TLV - type: router ID | 2 bytes: 0003 |
| TLV - length | 2 bytes: 0004 |
| TLV - value | 4 bytes: router ID encoded in little endian |
| TLV - type: conduits | 2 bytes: 0004 |
| TLV - length | 2 bytes: each conduit is 4 bytes long. |
| TLV - value | Variable length: conduit ID is unique within the |
| | network. |
| TLV - type: area | 2 bytes: 0005 |
| TLV - length | 2 bytes: 0004 |
| TLV - value | 4 bytes: area ID. |

The Link Manager on the PIC card uses the “contact interval” specified by the peer as the longest interval without receiving a Peer Discovery packet. This value should be long enough for the line card to reboot and resume transmitting peer discovery packets. Once this duration is exceeded lost of contact with the peer is presumed and the consistency of optical routing parameters cannot be assumed to be consistent. This indication can be used to prevent further circuits from being allocated on this trunk (existing circuits must not be affected).

The following sections discuss the interface to the various modules. The following is a definition of a port identifier.

| Name | Values | Description |
|---|---|---|
| Chassis number | 5 bits allowing values in the | |
| | range of [0..31] | |
| PIC card slot | 5 bits allowing values in the | |
| number | range of [0..31] | |
| Port Number | 6 bits allowing values in the | |
| | range of [0..63] | |
| Channel Number | 16 bits allowing values in the | The value zero does not specify a channel. For |
| | range of [0..65535]. | example, the trunk manager has no knowledge |
| | | about channels and would always set this field |
| | | to zero. |

Optical Routing

The Trunk Manager sends Trunk Add, Trunk Delete and Trunk Bandwidth Update commands. The Trunk Manager processes asynchronous events from the Resource Manager and Port Manager that may require Optical Routing commands to be forwarded.

Trunk Add

The Trunk Manager issues a “Trunk Add” command for a tunk either when it has discovered the peer's [router ID, port ID, area ID], or when it receives a “Trunk Add” indication with these parameters configured by the user. If the trunk is a member of an APS pair (Trunk Protection Strategy=protect, 1+1 or 1:1), then the Trunk Manager must ensure the pair of ports have identical [router ID, port ID, area ID]. The Trunk Add command can be issued to update a trunk's parameters. Optical Routing does not advertise a trunk until it has received both a “Trunk Add” and “Trunk Bandwidth Update” command. In the case of a 1+1 APS pair of trunks, one “Trunk Add” command is issued for this logical trunk. In the case of a 1:1 APS pair of trunks, one “Trunk Add” command is issued for the APS pair and another for the protect trunk, which can have bandwidth allocated independently.

| Name | TLV Number | Description |
|---|---|---|
| Port ID | 5 | This is a 32-bit integer value, specifying the |
| | | local trunks logical identifier. |
| Peer's OSPF Router ID | 22 | This value is either configured by the user or |
| | | discovered by the in-band control channel's |
| | | datalink layer on the PIC card. |
| Remote Port ID | 23 | Peer's logical trunk identifier. This value is |
| | | either configured by the user or discovered by |
| | | the in-band control channel's datalink layer on |
| | | the PIC card. |
| OSPF Area ID | 3 | Peer's OSPF area ID. This value is either |
| | | configured by the user or discovered by the in- |
| | | band control channel's datalink layer on the |
| | | PIC card. |
| Trunk Protection | 6 | Configured by the user and may be updated by |
| Strategy | | Interface Hierarchy Manager with the |
| | | operating value. For the initial release, the |
| | | following values are supported: none, protect, |
| | | 1 + 1, 1:1. Other values are defined by the OR |
| | | Interface spec but are not supported in the |
| | | initial release. |
| VPN ID | 7 | Configured by the user. An ID = 0 is defined as |
| | | public. |
| Conduit List | 8 | Configured by the user. |
| Link Transparency | 9 | For the initial release, it is always set to Line. |
| Administrative Cost | 11 | Configured by the user. Similar to the OSPF |
| | | interface cost that takes values in the range of |
| | | [1..65535]. |
| Protect Port ID | 21 | If the “Trunk Protection Strategy” has been |
| | | specified as 1 + 1 or 1:1, which implies this is |
| | | the APS working port, then this parameter |
| | | specifies the logical port used for APS |
| | | protection. |

Trunk Bandwidth Update

The Trunk Manager issues a “Trunk Bandwidth Update” command to indicate the amount of bandwidth currently available for the specified trunk. Initially, the Trunk Manager issues this command to indicate the trunk's bandwidth capacity. The units used to specify bandwidth is STS-1. For example, an OC-3 has bandwidth equal to 3. The Trunk Manager issues the Trunk Bandwidth Update command as a result of Signaling's Resource Manager successfully allocating or freeing bandwidth, or when APS switches to its protect port in a 1:1 configuration, the protected port must indicate its trunk bandwidth is now zero.

| | TLV | |
|---|---|---|
| Name | Number | Description |
| Port ID | 5 | Local trunk identifier. |
| Available Tx Bw | 10 | The amount of payload |
| | | bandwidth available. |
| Available Rx Bw | 12 | Similar to the above entry, but in |
| | | the Rx direction. |
| Assigned Preemptible | 13 | The amount of payload |
| Tx Bw | | bandwidth used, that may be |
| | | preempted. This is only |
| | | applicable for a protected link |
| | | (1 + 1 or 1:N), other link types will |
| | | always have this set to zero. |
| Assigned Preemptible | 15 | Similar to the above entry, but in |
| Rx Bw | | the Rx direction. This is only |
| | | applicable for a protected link |
| | | (1 + 1 or 1:N), other link types will |
| | | always have this set to zero. |

Trunk Delete

Trunk Delete is indicated when the configuration is deleted.

1+1 APS Ports

The Trunk Manager represents a pair of 1+1 APS trunks as one logical trunk to Optical Routing. The Trunk Add command is issued once it has been verified that both trunks are connected to the same peer SN16000. The following chart indicates how the trunk manager reconfigures the trunks, via Optical Routing and notifies Signaling when trunk is down. When one of the ports is down, any circuit can be routed over a 1+1 trunk operating on its protect port; once the working port is restored, circuits not requiring protection would (incorrectly) get the benefit of 1+1 protection for free.

[image]

1:1 APS Ports

The Trunk Manager represents a pair of 1:1 APS trunks as two logical trunks to Optical Routing. The first trunk represents the APS pair, the second trunk represents the protect trunk. The Trunk Add command is issued once it has been verified that both trunks are connected to the same peer SN16000. The following figure shows how the Trunk Manager reconfigures the trunks, via Optical Routing and notifies Signaling when the trunk is down. “Assigned preemptible bandwidth” is always set to zero on the protect trunk. 1:1 Trunk protection is only indicated when both trunks are up. Although the MIB may be configured with 1:1, in the case where the other end of the trunk is configured with 1+1, APS negotiates down to 1+1. Optical routing is configured with the APS negotiated value.

[image]

Unprotected Ports

The following chart illustrates how the Trunk Manager reconfigures the trunks, via Optical Routing and notifying Signaling, based on the state of the unprotected trunk. The “assigned preemptible bandwidth” is set to zero on the protect trunk.

[image]

Trunk Manageable Parameters

The following table is the internal MIB representation of the Trunk parameters. The user is prompted for these parameters as part of the port configuration if it is defined as a trunk. Parameters are presented to the user as part of the Port parameters. Port parameters are described in the Port Interface Card specification. The protection level and working/protect port identifiers are specified in the APS MIB. Some parameters, which are indicated with an underscore, have no appropriate default value. If PeerDiscovery is false, the user provides values for PeerRouterld, PeerChassis, PeerSlot, PeerPort. If PeerDiscovery is true, the user is free to either leave these parameters blank or assert a value. A blank parameter has no corresponding TLV generated for the createObject. The choices presented to the user for IpoverSonetPhys are:

None=0×0000

Line=0×4FF8

Section+Line=0×7FFF

| Manageable Object | Values | Default | Description |
|---|---|---|---|
| Chassis | 32 bit integer | — | This is the local chassis number of the |
| | | | trunk. This is the first of three indexes for |
| | | | this record. |
| Slot | Integer in the range of [1..16] | — | This is the local slot number of the trunk. |
| | | | This is the second of three indexes for this |
| | | | record. |
| Port | Integer in the range of [1..8] | — | This is the port number of the trunk. This |
| | | | is the third of three indexes for this |
| | | | record |
| IpoverSonetPhys | Bitwise mask using an | 0 | This parameter specifies the SONET |
| | integer. The bits are defined | | overhead bytes used for inter-SN16000 IP |
| | as follows: | | connectivity. Each bit selects a SONET |
| | Bit 0 is DCC1, | | overhead byte. A value of zero indicates |
| | Bit 1 is DCC2, | | no overhead byte is selected and therefore |
| | . . . , | | no IP connectivity is provided. The MIB |
| | bit 11 is DCC12, | | representation supports any combination |
| | bit 12 is F1, | | of the bits to be enabled. |
| | bit 13 is E1, | | |
| | bit 14 is E2. | | |
| PeerDiscovery | Boolean | True | True indicates the in-band control |
| | | | channel will be used to discover the peer |
| | | | node's Optical Routing parameters. Peer |
| | | | discovery includes PeerRouterId, |
| | | | PeerChassis, PeerSlot and PeerPort. |
| PeerRouterId | Dot notation IP address such | — | Remote SN16000's SMC router ID. |
| | as w.x.y.z | | |
| PeerChassis | 32 bit integer | — | This is the peer's chassis number of the |
| | | | trunk. Typically this parameter is |
| | | | discovered and is not configured by the |
| | | | user. |
| PeerSlot | Integer in the range of [1..16] | — | This is the peer's slot number of the |
| | | | trunk. Typically this parameter is |
| | | | discovered and is not configured by the |
| | | | user. |
| PeerPort | Integer in the range of [1..8] | — | This is the peer's port number of the |
| | | | trunk. Typically this parameter is |
| | | | discovered and is not configured by the |
| | | | user. |
| OspfAreaId | Dot notation IP address such | 0.0.0.1 | Trunk's OSPF area ID. |
| | as w.x.y.z | | |
| VPN | 32 bit integer. Zero indicates | 0 | Virtual Private Network. |
| | public resources. | | |
| Conduits | Comma separated list of 32 | — | Identifies a list of conduits used by |
| | bit integers. | | Optical Routing. |
| AdminCost | 32 bit integer. | 100 | Similar to OSPF interface cost. Must be |
| | | | in the range of [1..65535]. |

PIC Design Notes

Configuration and operation of MPC8260 SCCs is done through its DPRAM. Two MPC8260s are used to support the 8 control channels per PIC 52. The first MPC8260 operates as a master, its PPC core and communication processor are enabled. The second MPC8260 operates as a slave, only its communication processor is enabled. The PPC/CP interface is implemented in DPRAM and access to a specific SCC is memory mapped. The location of the DPRAM is relative to the IMMR register. The MPC8260 user's guide section 5.4.1 describes how IMMR is configured during power on reset. This procedure allows the DPRAM of each MPC8260 to be assigned a unique section of memory.

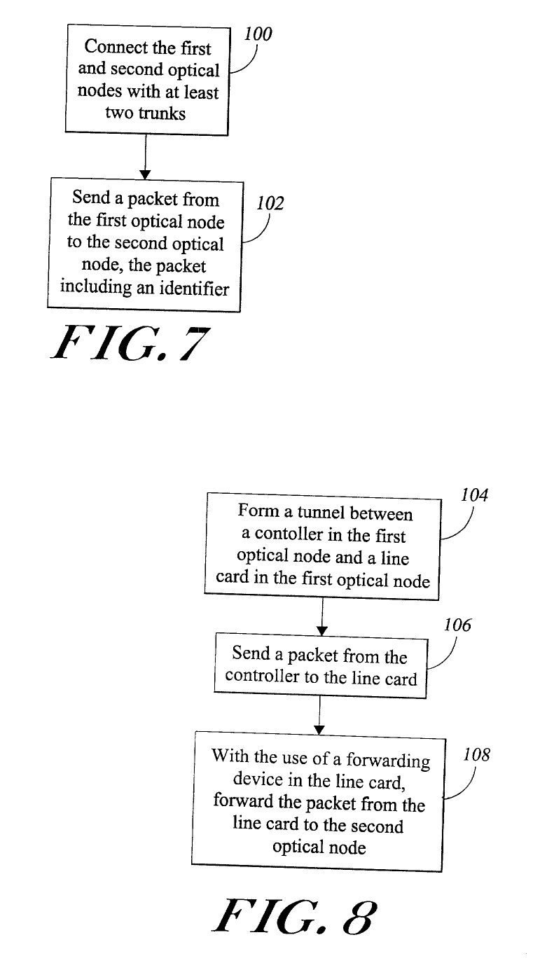

Referring to FIG. 7, a flow chart is presented for peer discovery between a first optical node 10A and a second optical node 10B. In step 100, the first optical node 10A and the second optical node 10B are connected with at least two trunks 12. Subsequently, in step 102, a packet is sent from the first optical node 10A to the second optical node 10B, the packet including an identifier. The identifier can include at least one of a router identification, a chassis number, a slot number, and a port number. As detailed above, the packet is sent over an in-band control channel, and originates in a management controller 28 in the first optical node 10A. In one embodiment, a trunk manager module on the management controller 28 performs the peer discovery.

Referring to FIG. 8, a flow chart is presented for establishing Internet Protocol (IP) connectivity between a first optical node 10A and a second optical node 10B connected by at least one trunk 12. In step 104, a tunnel 90, 92 is formed between a controller 28 in the first optical node 10A and a line card 52 in the first optical node 10A. In step 106, a packet is sent from the controller 28 to the line card 52. Subsequently, in step 108, with the use of a forwarding device 61 in the line card 52, the packet is forwarded from the line card 52 to the second optical node over the at least one trunk. The trunk 12 can be a SONET trunk, for example.

In one embodiment, redundant IP connectivity over SONET trunks can be provisioned between two optical nodes. From the set of IP connections between a pair of optical nodes, no more than one IP connection would be selected to forward IP packets. An eligible IP connection has no SONET alarms outstanding on its associated trunk, and OSPF forms an adjacency over the IP connection. In the event the selected trunk is no longer eligible, an eligible redundant IP connection can be promoted as the selected IP connection to forward IP packets.

While the present invention has been described with reference to illustrative embodiments thereof, those skilled in the art will appreciate that various changes in form and detail may be made without departing from the intended scope of the present invention as defined in the appended claims.

What is claimed:

1. A method for peer discovery between a first optical node and a second optical node, the method comprising:
a) connecting the first optical node and the second optical node with at least two trunks; and
b) sending a packet from the first optical node to the second optical node, said packet including an identifier.

2. The method of claim 1, wherein, in the step of sending, the packet is sent over an in-band control channel.

3. The method of claim 1, wherein, in the step of sending, the packet originates in a management controller in the first optical node.

4. The method of claim 3, wherein, in the step of sending, a trunk manager module on the management controller enables the peer discovery.

5. The method of claim 1, wherein, in the step of sending, the packet is sent from a port interface card in the first optical node to the second optical node.

6. The method of claim 1, wherein, in the step of sending, the identifier includes at least one of a router identification, a chassis number, a slot number, and a port number.

7. The method of claim 1, wherein, in the step of sending, the packet further includes an optical routing parameter.

8. The method of claim 7, wherein, in the step of sending, the optical routing parameter includes at least one of a virtual private number associated with at least one of the trunks, a conduit number associated with at least one of the trunks, and an OSPF area identification.

9. A method for peer discovery between a first optical node and a second optical node, the method comprising:
a) connecting the first optical node and the second optical node with at least one trunk; and
b) sending a packet from the first optical node to the second optical node, said packet including an identifier, and an optical routing parameter.

10. The method of claim 9, wherein, in the step of sending, the packet is sent over an in-band control channel.

11. The method of claim 9, wherein, in the step of sending, the packet originates in a management cont roller in the first optical node.

12. The method of claim 11, wherein, in the step of sending, a trunk manager module on the management controller performs the peer discovery.

13. The method of claim 9, wherein, in the step of sending, the packet is sent from a port interface card in the first optical node to the second optical node.

14. The method of claim 9, wherein, in the step of sending, the identifier includes at least one of a router identification, a chassis number, a slot number, and a port number.

15. The method of claim 9, wherein, in the step of sending, the optical routing parameter includes at least one of a virtual private number associated with the at least one trunk, a conduit number associated with the at least one trunk, and an OSPF area identification.

16. A system for peer discovery between a first optical node and a second optical node, the system comprising
a) a controller in the first optical node;
b) a line card in the first optical node linked to the controller; and
c) a trunk manager module on the controller for sending a packet to the second optical node via the line card, said packet including an identifier and an optical routing parameter.

17. The system of claim 16, wherein the identifier includes at least one of a router identification, a chassis number, a slot number, and a port number.

18. The system of claim 16, wherein the optical routing parameter includes at least one of a virtual private number associated with the at least one trunk, a conduit number associated with the at least one trunk, and an OSPF area identification.

19. A method of establishing Internet Protocol (IP) connectivity between a first optical node and a second optical node connected by at least one trunk, the method comprising:
a) forming a tunnel between a controller in the first optical node and a line card in the first optical node;
b) sending a packet from the controller to the line card; and
c) with the use of a forwarding device in the line card, forwarding the packet from the line card to the second optical node over the at least one trunk,
thereby establishing a first IP connection between the first optical node and the second optical node to forward IP packets.

20. The method of claim 19, wherein, in the step of forwarding, the trunk is a synchronous optical network (SONET) trunk.

21. The method of claim 20, further comprising establishing a second IP connection between the first optical node and the second optical node, said second IP connection utilized to forward IP packets if the first IP connection becomes ineligible.
